(19) United States
(12) Patent Application Publication
(10) Pub. No.: US 2012/0194602 A1
(43) Pub. Date: Aug. 2, 2012

(54) ASSEMBLY METHOD OF INKJET PRINTHEAD ASSEMBLY AND INKJET PRINTHEAD ASSEMBLY USING THE SAME

(75) Inventors: Hyun Ho SHIN, Gyeonggi-do (KR); Tae Kyung Lee, Gyeonggi-do (KR); Hwa Sun Lee, Gyeonggi-do (KR); Seung Heon Han, Seoul (KR)

(73) Assignee: SAMSUNG ELECTRO-MECHANICS CO., LTD.

(21) Appl. No.: 13/330,051

(22) Filed: Dec. 19, 2011

(30) Foreign Application Priority Data
Jan. 28, 2011 (KR) 10-2011-0008824

(51) Int. Cl. B41J 2/015; B21D 53/76

(52) U.S. Cl. 347/20; 29/890.1

(57) ABSTRACT

The present invention relates to an assembly method of an inkjet printhead assembly and an inkjet printhead assembly using the same, and more particularly, to an assembly method of an inkjet printhead assembly capable of securing a relative position between nozzles within a small error range in an inkjet printhead assembly having a side shooting head structure in which two or more head chips are bonded to a single bezel, and an inkjet printhead assembly using the same.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0008824, entitled filed Jan. 28, 2011, which is hereby incorporated by reference in its entirety into this application.

### BACKGROUND OF THE INVENTION

1. Field of the Invention

The present invention relates to an assembly method of an inkjet printhead assembly and an inkjet printhead assembly using the same, and more particularly, to an assembly method of an inkjet printhead assembly capable of securing a relative position between nozzles within a small error range in an inkjet printhead assembly having a side shooting head structure in which two or more head chips are bonded to a single bezel, and an inkjet printhead assembly using the same.

2. Description of the Related Art

In general, an inkjet printhead is a structure which converts an electrical signal into physical strength to eject ink in the form of droplets through a small nozzle. Especially, an inkjet head assembly consists of an inkjet head having a nozzle plate and a cartridge for supplying ink to the inkjet head.

Recently, a piezoelectric inkjet head is also used in an industrial inkjet printer. For example, the piezoelectric inkjet head directly forms a circuit pattern by spraying a functional metal ink including fine metal particles such as gold and silver on a printed circuit board (PCB) or is used in industrial graphics or a liquid crystal display (LCD), manufacture of an organic light emitting diode (OLED), a solar battery, and so on.

Especially, in case of a graphic inkjet printer, a plurality of inkjet heads are mounted for high resolution printing. Due to this, there is a disadvantage that size or volume of an inkjet printhead assembly to which inkjet heads are mounted is increased. This causes the larger and heavier carriage in a conventional wide-format printer. Bigger carriage also causes a substantial increase of carriage-driving unit and thus substantially increases manufacturing cost of equipment.

According to these circumstances, an inkjet printhead assembly having a two-line side shooting head structure, which effectively disposes a plurality of inkjet printheads in a narrow space to minimize a size thereof as well as increase integration of the inkjet printheads, is developed.

As shown in FIGS. 1 and 2, the two-line side shooting head structure has advantages that it can improve resolution two times as well as increase integration by bonding a first head chip 10a and a second head chip 10b to both side surfaces of a bezel 20 in which an ink inlet 30 is formed.

In general, a process of bonding a first head chip and a second head chip to both side surfaces of a bezel is performed manually. However, there is a problem that it is very difficult to accurately position nozzles of the both head chips due to an error occurred during processing of the bezel, an error occurred in a process of dicing the exterior of the first and second head chips, a position error occurred due to manual work during bonding, and so on.

### SUMMARY OF THE INVENTION

The present invention has been invented in order to overcome the above-described problems and it is, therefore, an object of the present invention to provide an assembly method of an inkjet printhead assembly capable of securing a relative position between nozzles within a small error range in an inkjet printhead assembly having a side shooting head structure in which two or more head chips are bonded to a single bezel, and an inkjet printhead assembly using the same.

In accordance with one aspect of the present invention to achieve the object, there is provided an assembly method of an inkjet printhead assembly including: preparing a bezel having at least one ink inlet outside and a common passage inside; forming through holes in the bezel and first and second head chips to couple the first and second head chips to both side surfaces of the bezel in parallel; and fixing the first head chip, the bezel, and the second head chip to a bonding jig, to which fixing pins are mounted, to pass the fixing pins through the through holes formed in the first and second head chips and the bezel.

Here, a diameter of the through hole may be larger than that of the fixing pin by 5 to 15 μm.

Meanwhile, in accordance with another aspect of the present invention to achieve the object, there is provided an assembly method of an inkjet printhead assembly including: preparing a bezel having at least one ink inlet outside, a common passage inside, and one or more uneven portions on both side surfaces; forming through holes in first and second head chips to couple the first and second chips to the both side surfaces of the bezel, on which the uneven portions are formed, in parallel; and coupling the bezel and the first and second head chips by passing the uneven portions through the through holes formed in the first and second head chips.

Here, a diameter of the through hole may be larger than that of the uneven portion by 5 to 15 μm.

Meanwhile, in accordance with another aspect of the present invention to achieve the object, there is provided an assembly method of an inkjet printhead assembly including: preparing a bezel having at least one ink inlet outside, a common passage inside, and one or more uneven portions on both side surfaces; forming grooves in end portions of first and second head chips to couple the first and second head chips to the both side surfaces of the bezel, on which the uneven portions are formed, in parallel; and coupling the bezel and the first and second head chips by fitting the uneven portions in the grooves formed in the first and second head chips.

Here, a cross section of the uneven portion formed in the bezel may be oval.

Meanwhile, in accordance with another aspect of the present invention to achieve the object, there is provided an assembly method of an inkjet printhead assembly including: preparing a bezel having at least one ink inlet outside and a common passage inside; forming through holes in the bezel and first and second head chips to couple the first and second head chips to both side surfaces of the bezel in parallel; and fixing the first head chip, the bezel, and the second chip to a bezel cover, to which fixing pins are mounted, to pass the fixing pins through the through holes formed in the first and second head chips and the bezel.

Here, a diameter of the through hole may be larger than that of the fixing pin by 5 to 15 μm.

Meanwhile, in accordance with another aspect of the present invention to achieve the object, there is provided an inkjet printhead assembly completed by being assembled by one of the above methods.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view showing an inkjet printhead assembly in accordance with the present invention;

FIG. 2 is a plan view of the inkjet printhead assembly of FIG. 1;

FIG. 3 is a schematic diagram of an assembly method of an inkjet printhead assembly using a bonding jig in accordance with an embodiment of the present invention;

FIG. 4 is a schematic diagram of an assembly method of an inkjet printhead assembly using a bezel with uneven portions in accordance with another embodiment of the present invention;

FIG. 5 is a schematic diagram of an assembly method of an inkjet printhead assembly using a head chip with grooves in accordance with another embodiment of the present invention; and

FIG. 6 is a schematic diagram of an assembly method of an inkjet printhead assembly using a bezel cover with fixing pins in accordance with another embodiment of the present invention.

### DETAILED DESCRIPTION OF THE PREFERABLE EMBODIMENTS

Hereinafter, preferable embodiments of the present invention will be described in detail to enable those skilled in the art to easily make and use the invention.

Terms or words used in the present specification and claims should not be interpreted as being limited to typical or dictionary meanings, but should be interpreted as having meanings and concepts relevant to the technical spirit of the present invention based on the rule according to which an inventor can appropriately define the concept of the term to describe his/her own invention in the best manner.

Therefore, configurations shown in embodiments and the drawings of the present invention rather are examples of the most exemplary embodiment and do not represent all of the technical spirit of the invention. Thus, it will be understood that various equivalents and modifications that replace the configurations are possible when filing the present application.

Hereinafter, embodiments of the present invention will be described in detail with reference to the accompanying drawings.

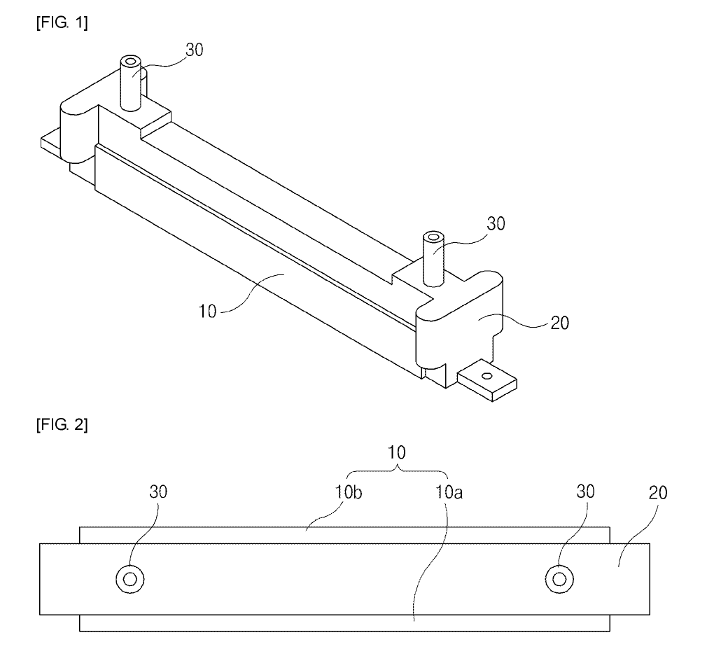

FIGS. 1 and 2 a perspective view and a plan view of an inkjet printhead assembly in accordance with the present invention, respectively.

An inkjet printhead assembly in accordance with the present invention includes a head chip 10 and a bezel 20.

The head chip 10 includes a first head chip 10a and a second head chip 10b. Although not shown, the head chip 10 includes a head plate having a passage structure inside and a piezoelectric element.

The head plate is a rectangular parallelepiped structure formed by laminating a plurality of silicon substrates. It is preferred that the head chip 10 of the present embodiment is a side shooting head of which nozzles are formed in a longitudinal direction to eject ink to side surfaces of the head plate.

The bezel 20 forms a frame of the inkjet printhead assembly and plays a role of supporting other components. For this, at least one ink inlet 30 is formed outside the bezel 20 in accordance with the present embodiment.

The head chip 10 is coupled to both side surfaces of the bezel 20. In the inkjet printhead assembly in accordance with the present embodiment, the two head chips 10a and 10b are disposed in parallel to be bonded to the bezel 20.

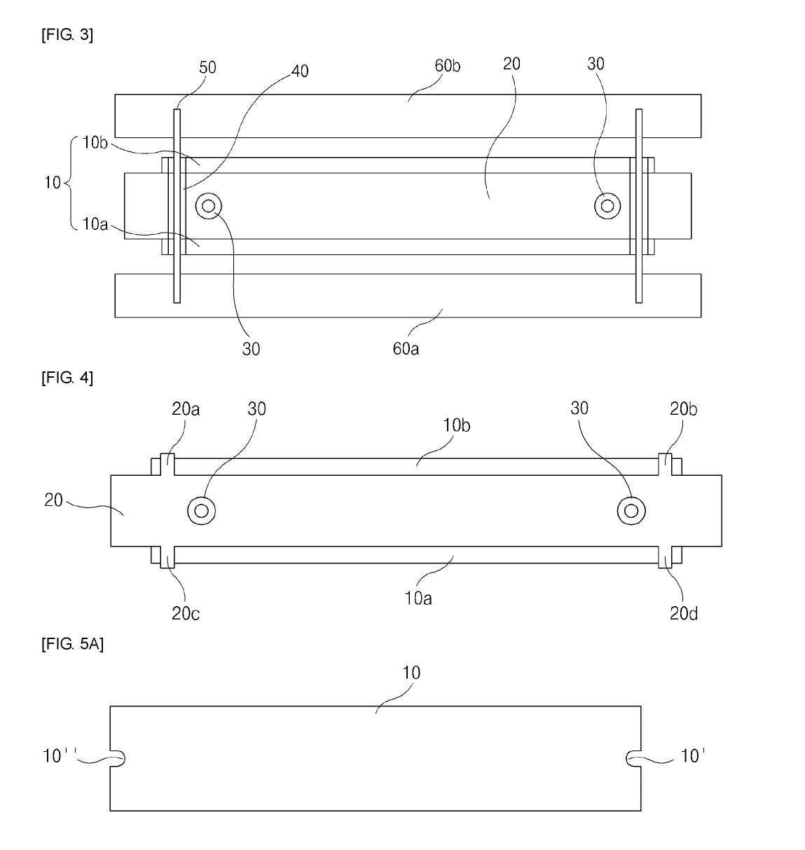

FIG. 3 shows an assembly method of an inkjet printhead assembly using a bonding jig in accordance with an embodiment of the present invention. An assembly method of an inkjet printhead assembly of the present invention includes the steps of preparing a bezel 20 having at least one ink inlet 30 outside and a common passage inside, forming through holes 40 in the bezel 20 and first and second head chips 10a and 10b to couple the first and second head chips 10a and 10b to both side surfaces of the bezel 20 in parallel, and fixing the first head chip 10a, the bezel 20, and the second head chip 10b to bonding jigs 60a and 60b, to which fixing pins 50 are mounted, to pass the fixing pins 50 through the through holes 40 formed in the first and second head chips 10a and 10b and the bezel 20.

One of the two ink inlets 30 of the bezel 20 may be used as an ink outlet.

The through holes 40 of the head chip 10 and the bezel 20 are formed by a MEMS process technology.

The bonding jig 60 is a means used for assembly of the inkjet printhead assembly of the present invention and not a component constituting the assembly of the present invention.

A method of bonding the head chip 10 using the bonding jig 60 fixes the head chip 10 to the fixing pin 50 mounted to the bonding jig 60 after applying an adhesive for attaching the head chip 10 to the bezel 20.

For this, the through hole 40 slightly larger than the fixing pin 50 is formed in the bezel 20. Here, it is preferred that a diameter of the through hole 40 is larger than that of the fixing pin 50 by 5 to 15 μm.

When the bezel 20 and the head chip 10 with the through holes 40 are prepared, after the first head chip 10a, the bezel 20, and the second head chip 10b are sequentially fixed to the fixing pin 50 by the bonding jig 60, the head chip 10 is fixed to the bezel 20 by applying pressure adequate not to cause damage to the head chip 10 in a state in which the bonding jig 60 is mounted.

In this case, the first and second head chips 10a and 10b have only an alignment error corresponding to the degree of processing of the fixing pin 50. That is, when the fixing pin 50 is precisely processed, the first and second head chips 10a and 10b have the degree of precision corresponding to that. Although there are a few processing errors of the fixing pin 50, the alignment errors are not greatly increased.

Meanwhile, FIG. 4 shows a schematic diagram of an assembly method of an inkjet printhead assembly using a bezel with uneven portions in accordance with another embodiment of the present invention. An assembly method of an inkjet printhead assembly in accordance with another embodiment of the present invention includes the steps of preparing a bezel 20 having at least one ink inlet 30 outside, a common passage inside, and one or more uneven portions 20a, 20b, 20c, and 20d on both side surfaces, forming through holes in first and second head chips 10a and 10b to couple the first and second head chips 10a and 10b to the both side surfaces of the bezel 20, on which the uneven portions 20a, 20b, 20c, and 20d are formed, in parallel, and coupling the bezel 20 and the first and second head chips 10a and 10b by passing the uneven portions 20a, 20b, 20c, and 20d through the through holes formed in the first and second head chips 10a and 10b.

The through hole 40 of the head chip 10 is formed by a MEMS process technology.

It is preferred that one or more uneven portions 20a, 20b, 20c, and 20d are formed in the bezel 20 to reduce errors during bonding. As shown in FIG. 4, fixing the head chip 10 by the two uneven portions 20a, 20b, 20c, and 20d is the most suitable to improve process efficiency and reduce errors.

There is no limitation on methods of forming the uneven portions 20a, 20b, 20c, and 20d, but it is common to form the uneven portions 20a, 20b, 20c, and 20d by an injection method during formation of the bezel 20.

A method of bonding the first head chip 10a and the second head chip 10b using the uneven portions 20a, 20b, 20c, and 20d formed in the bezel 20 fixes the first head chip 10a and the second head chip 10b to each of the uneven portions 20a, 20b, 20c, and 20d formed in the bezel 20 after applying an adhesive for attaching the first head chip 10a and the second head chip 10b to the bezel 20.

For this, the through holes (not shown) slightly larger than the uneven portions 20a, 20b, 20c, and 20d are formed in the head chip 10. Here, it is preferred that a diameter of the through hole is larger than that of the uneven portion by 5 to 15 μm.

When the bezel 20 with the uneven portions 20a, 20b, 20c, and 20d and the head chip 10 are prepared, after the first head chip 10a, the bezel 20, and the second head chip 10b are sequentially fixed by coupling the uneven portions 20a, 20b, 20c, and 20d and the through holes, the head chip 10 is attached to the bezel 20 by applying pressure adequate not to cause damage to the head chip 10 in this state.

In this case, the first and second head chips 10a and 10b have only an alignment error corresponding to the degree of processing of the uneven portions 20a, 20b, 20c, and 20d. That is, when the uneven portions 20a, 20b, 20c, and 20d are precisely processed, the first and second head chips 10a and 10b have the degree of precision corresponding to that. Although there are a few processing errors of the uneven portions 20a, 20b, 20c, and 20d, the alignment errors are not greatly increased.

Meanwhile, FIG. 5 shows a schematic diagram of an assembly method of an inkjet printhead assembly using a head chip with grooves in accordance with another embodiment of the present invention. An assembly method of an inkjet printhead assembly in accordance with another embodiment of the present invention includes the steps of preparing a bezel 20 having at least one ink inlet 30 outside, a common passage inside, and one or more uneven portions 20′ on both side surfaces, forming grooves 10′ and 10″ in end portions of first and second head chips 10a and 10b to couple the first and second head chips 10a and 10b to the both side surfaces of the bezel 20, on which the uneven portions 20′ are formed, in parallel, and coupling the bezel 20 and the first and second head chips 10a and 10b by fitting the uneven portions 20′ in the grooves 10′ and 10″ formed in the first and second head chips 10a and 10b.

The grooves 10′ and 10″ of the head chip 10 are formed by a MEMS process technology. As shown in FIG. 5(a), it is preferred that the grooves 10′ and 10″ are formed in the both end portions of the head chip 10.

It is preferred that one or more uneven portions 20′ are formed in the bezel 20 to reduce errors during bonding. As shown in FIG. 5(b), fixing the head chip 10 by the two uneven portions 20′ is the most suitable to improve process efficiency and reduce errors.

There is no limitation on methods of forming the uneven portions 20′, but it is common to form the uneven portions 20′ by an injection method during formation of the bezel 20.

A method of bonding the first head chip 10a and the second head chip 10b using the uneven portions 20′ formed in the bezel 20 applies power to closely fit the uneven portions 20′ formed in the bezel 20 in the grooves 10′ and 10″ formed in the first head chip 10a and the second head chip 10b after applying an adhesive for attaching the first head chip 10a and the second head chip 10b to the bezel 20. Here, it is preferred that a cross section of the uneven portion 20′ formed in the bezel 20 is oval.

When the bezel 20 with the uneven portions 20′ and the head chip 10 are prepared, after the first head chip 10a, the bezel 20, and the second head chip 10b are sequentially pushed and fixed to couple the uneven portions 20′ and the grooves 10′ and 10″, the head chip 10 is attached to the bezel 20 by applying pressure adequate not to cause damage to the head chip 10 in this state.

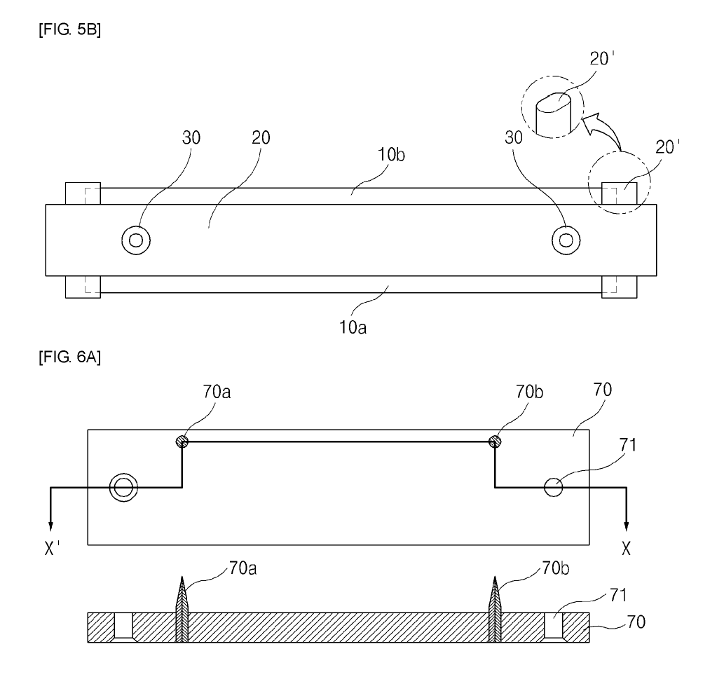

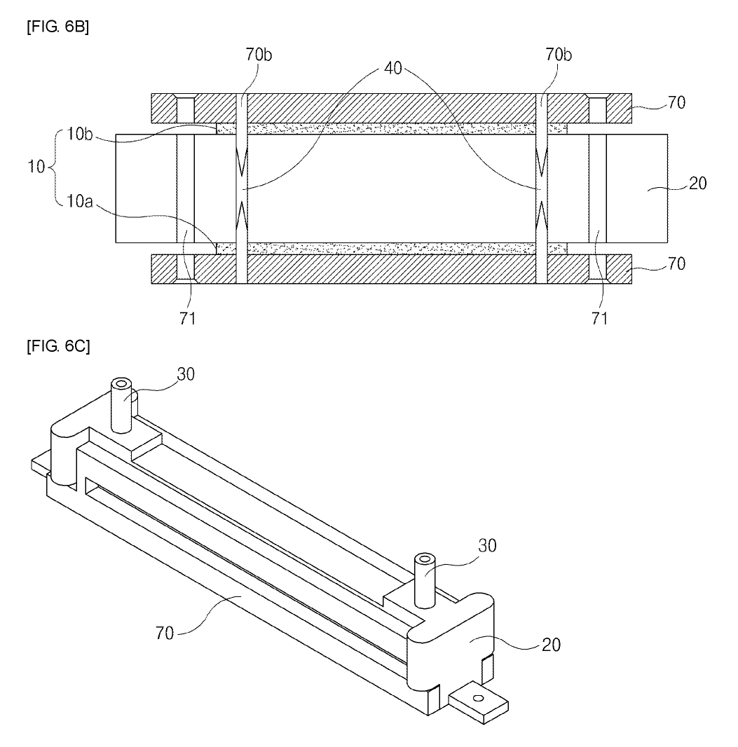

Meanwhile, FIG. 6 shows a schematic diagram of an assembly method of an inkjet printhead assembly using a bezel cover 70 with fixing pins in accordance with another embodiment of the present invention. An assembly method of an inkjet printhead assembly in accordance with another embodiment of the present invention includes the steps of preparing a bezel 20 having at least one ink inlet 30 outside and a common passage inside, forming through holes 40 in the bezel 20 and first and second head chips 10a and 10b to couple the first and second head chips 10a and 10b to both side surfaces of the bezel 20 in parallel, and fixing the first head chip 10a, the bezel 20, and the second head chip 10b to a bezel cover 70, to which fixing pins 70a and 70b are mounted, to pass the fixing pins 70a and 70b through the through holes 40 formed in the first and second head chips 10a and 10b and the bezel 20.

Specifically, FIG. 6(a) shows a structure in which the fixing pins 70a and 70b are bonded to the bezel cover 70. At this time, it is preferred that one ends of the fixing pins 70a and 70b have a conical needle shape to be aligned simultaneously with insertion.

FIG. 6(b) shows a method of bonding the head chips 10 to the bezel 20 in a two-line structure by using the bezel cover 70 to which the fixing pins 70a and 70b are bonded. A bonding sequence is as follows. First, the head chip 10 is bonded to each bezel cover 70 after applying an adhesive to the bezel 20. At this time, the fixing pins 70a and 70b of the bezel cover 70 are inserted through the both through holes (not shown) formed in the head chip 10, and it is fine to use a separate adhesive. After the head chip 10 is completely inserted in the bezel cover 70, the fixing pins 70a and 70b of the bezel cover 70 are inserted in the through holes 40 in the bezel 20. At this time, the through hole 40 may be formed by high precision drilling and so on.

An inkjet printhead assembly assembled using the bezel cover 70 is shown in FIG. 6(c). The inkjet printhead assembly additionally having the bezel cover 70 is completed by separately fixing the bezel cover 70 through screw assembly holes 71 formed in the bezel cover 70.

Meanwhile, in order to achieve the object, the present invention includes an inkjet printhead assembly completed by being assembled by one of the above methods. According to the above methods, few errors occur in positioning first and second head chips bonded to a bezel and thus there is an effect that reliability of products is high.

Although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An assembly method of an inkjet printhead assembly comprising:
preparing a bezel having at least one ink inlet outside and a common passage inside;
forming through holes in the bezel and first and second head chips to couple the first and second head chips to both side surfaces of the bezel in parallel; and
fixing the first head chip, the bezel, and the second head chip to a bonding jig, to which fixing pins are mounted, to pass the fixing pins through the through holes formed in the first and second head chips and the bezel.

2. The assembly method of an inkjet printhead assembly according to claim 1, wherein a diameter of the through hole is larger than that of the fixing pin by 5 to 15 μm.

3. An assembly method of an inkjet printhead assembly comprising:
preparing a bezel having at least one ink inlet outside, a common passage inside, and one or more uneven portions on both side surfaces;
forming through holes in first and second head chips to couple the first and second head chips to the both side surfaces of the bezel, on which the uneven portions are formed, in parallel; and
coupling the bezel and the first and second head chips by passing the uneven portions through the through holes formed in the first and second head chips.

4. The assembly method of an inkjet printhead assembly according to claim 3, wherein a diameter of the through hole is larger than that of the uneven portion by 5 to 15 μm.

5. An assembly method of an inkjet printhead assembly comprising:
preparing a bezel having at least one ink inlet outside, a common passage inside, and one or more uneven portions on both side surfaces;
forming grooves in end portions of first and second head chips to couple the first and second head chips to the both side surfaces of the bezel, on which the uneven portions are formed, in parallel; and
coupling the bezel and the first and second head chips by fitting the uneven portions in the grooves formed in the first and second head chips.

6. The assembly method of an inkjet printhead assembly according to claim 5,
wherein a cross section of the uneven portion formed in the bezel is oval.

7. An assembly method of an inkjet printhead assembly comprising:
preparing a bezel having at least one ink inlet outside and a common passage inside;
forming through holes in the bezel and first and second head chips to couple the first and second head chips to both side surfaces of the bezel in parallel; and
fixing the first head chip, the bezel, and the second head chip to a bezel cover, to which fixing pins are mounted, to pass the fixing pins through the through holes formed in the first and second head chips and the bezel.

8. The assembly method of an inkjet printhead assembly according to claim 7, wherein a diameter of the through hole is larger than that of the fixing pin by 5 to 15 μm.

9. An inkjet printhead assembly completed by being assembled according to one of claims 1 to 8.
